(19) United States
(12) Patent Application Publication
(10) Pub. No.: US 2011/0164118 A1
(43) Pub. Date: Jul. 7, 2011

(54) DISPLAY APPARATUSES SYNCHRONIZED BY ONE SYNCHRONIZATION SIGNAL

(75) Inventors: Young-hun CHOI, Hwaseong-si (KR); Sung-rae KANG, Seoul (KR); Young-jai BAI, Suwon-si (KR)

(73) Assignee: SAMSUNG ELECTRONICS CO., LTD., Suwon-si (KR)

(21) Appl. No.: 12/979,435

(22) Filed: Dec. 28, 2010

Related U.S. Application Data
(60) Provisional application No. 61/292,585, filed on Jan. 6, 2010.

(30) Foreign Application Priority Data
Mar. 8, 2010 (KR) 2010-0020579

(51) Int. Cl. H04N 13/04

(52) U.S. Cl. 348/51; 348/E13.059

(57) ABSTRACT

A display system is provided. The display system includes a plurality of display apparatuses synchronized by a synchronization signal to display an input image. Accordingly, the plurality of display apparatuses may synchronize a 3D image to be displayed, and thus a user may watch the 3D image displayed on the plurality of display apparatuses using 3D glasses.

### CROSS-REFERENCE TO RELATED APPLICATIONS

This application claims the benefit of U.S. Provisional Application No. 61/292,585, filed on Jan. 6, 2010, and claims priority from Korean Patent Application No. 10-2010-0020579, filed in the Korean Intellectual Property Office on Mar. 8, 2010, the disclosures of which are incorporated herein by reference in their entirety.

### BACKGROUND

1. Field

Apparatuses and methods consistent with exemplary embodiments relate to a display system, and more particularly, to a display system to synchronize three-dimensional (3D) images which are displayed in a plurality of display apparatuses.

2. Description of the Related Art

Three-dimensional (3D) stereoscopic image technology is applicable to various fields such as information communication, broadcasting, medicine, education and training, military, gaming, animation, virtual reality, computer aided drafting (CAD), industrial technology, etc. Furthermore, 3D stereoscopic image technology is regarded as a core base technology for a next generation 3D stereoscopic multimedia information communication, which may be used in all the aforementioned fields.

Generally, a stereoscopic sense that a person perceives occurs from a complex effect caused by: a degree of change in thickness of a person's eye lens according to a location of an object to be observed; an angle difference of the object observed from both eyes; differences in location and shape of the object observed from both eyes; a time difference due to movement of the object; and other various psychological and memory effects.

In particular, binocular disparity, caused by about a 6 to 7 cm lateral distance between the person's left eye and right eye, can be regarded as a main cause of the stereoscopic sense. Due to binocular disparity, the person perceives the object with an angle difference, which makes the left eye and the right eye receive different images. When these two images are transmitted to the person's brain through retinas, the brain can perceive the original 3D stereoscopic image by combining the two pieces of information exactly.

There are two types of related art stereoscopic image display apparatuses: glasses-type apparatuses which use special glasses; and nonglasses-type apparatuses which do not use such special glasses. A glasses-type apparatus may adopt a color filtering method which separately selects images by filtering colors which are in mutually complementary relationships, a polarized filtering method which separates the images received by a left eye from those received by a right eye using a light-shading effect caused by a combination of polarized light elements meeting at right angles, or a shutter glasses method which enables a person to perceive a stereoscopic sense by blocking a left eye and a right eye alternately in response to a sync signal which projects a left image signal and a right image signal to a screen.

A 3D image includes a left eye image perceived by the left eye and a right eye image perceived by the right eye. A 3D image display apparatus creates a stereoscopic sense using a time difference between the left eye image and the right eye image.

If a plurality of 3D display apparatuses that are simultaneously displaying 3D images are viewed by a single pair of 3D glasses, synchronization signals output from each display apparatus may not be consistent with each other. Since the left eye image and the right eye image of the 3D images output from each of the plurality of 3D display apparatuses alternates at a different time, it is difficult to view the 3D images displayed on the plurality of 3D image display apparatus with the single pair of 3D glasses.

Accordingly, a method for viewing 3D images displayed on a plurality of 3D display apparatuses that are not synchronized with each other using a single pair of 3D glasses is required.

### SUMMARY

Exemplary embodiments provide a display system which displays an input image by synchronizing a plurality of displays apparatuses with a single synchronization signal.

According to an aspect of an exemplary embodiment, there is provided a display system including: a plurality of display apparatuses which display an input image, wherein the plurality of display apparatuses are synchronized by a single synchronization signal to display the input image.

The input image may be a 3D image including a left eye image and a right eye image, and the plurality of display apparatuses may display the left eye image and the right eye image of the 3D image alternately according to the synchronization signal.

The display system may further include 3D glasses which receives a glasses controlling signal from at least one of the plurality of display apparatuses and synchronize periods when the left eye glasses and the right eye glasses are opened or closed according to the received glasses controlling signal, and the at least one of the plurality of display apparatuses may generate the glasses controlling signal using the synchronization signal and may transmit the generated glasses controlling signal to the 3D glasses.

In the display system, periods when a left eye image and a right eye image are displayed on the plurality of display apparatuses may be synchronized according to the synchronization signal, and periods when a left eye image and a right eye image of a 3D image are displayed on the plurality of display apparatuses may be synchronized with the periods when the left eye glasses and the right eye glasses of the 3D glasses are opened or closed according to the glasses controlling signal.

In the synchronization signal, a first period and a second period may be repeated; in the glasses controlling signal, the first period and the second period may be synchronized with the synchronization signal and be repeated; the plurality of display apparatuses may display the left eye images during the repeated first periods of the synchronization signal and may display the right eye images during the repeated second periods of the synchronization signal; and the 3D glasses may operate such that the left eye glasses are opened and the right eye glasses are closed during the first period and the left eye glasses are closed and the right eye glasses are opened during the second period.

The plurality of display apparatuses may receive a plurality of input images from a plurality of external apparatuses.

The plurality of display apparatuses may receive different images from the plurality of external apparatuses.

The plurality of display apparatuses may receive same images from the plurality of external apparatuses.

The plurality of display apparatuses may display different portions of the same images received from the plurality of external apparatuses.

The plurality of display apparatuses may receive the input image from at least two external apparatuses.

A reference display apparatus from among the plurality of display apparatuses may output the synchronization signal, and other display apparatuses other than the specific apparatus from among the plurality of display apparatuses may receive the synchronization signal and display images according to the received synchronization signal.

The reference display apparatus may include a first synchronization unit which outputs the synchronization signal for the image to be displayed on the reference display apparatus, and the first synchronization unit may include a first image input unit to which a first image signal is input, a first buffer which buffers the input first image signal by frame, a first image output unit which outputs the buffered first image signal, a first controlling unit which controls the buffer to output the buffered first image signal to the image output unit according to the synchronization signal included in the first image signal, and a synchronization signal output unit which outputs the synchronization signal; and the reference display apparatus may display the first image signal output from the image output unit.

The reference display apparatus may include a first synchronization unit which outputs the synchronization signal for the image to be displayed on the reference display apparatus, and the first synchronization unit may include a first image input unit to which a first image signal is input, a synchronization signal generating unit which generates the synchronization signal, a first buffer which buffers the input first image signal by frame, a first image output unit which outputs the buffered first image signal, a first controlling unit which controls the buffer to output the buffered first image signal to the image output unit according to the generated synchronization signal, and a synchronization signal output unit which outputs the synchronization signal; and the reference display apparatus may display the first image signal output from the image output unit.

The display system may further include a glasses transmitting unit which generates a glasses controlling signal to synchronize when left eye glasses and right eye glasses of 3D glasses are opened or closed using the synchronization signal and transmits the generated glasses controlling signal.

A display apparatuses other than the reference display apparatus from among the plurality of display apparatuses may include a second synchronization unit which outputs the image to be displayed on the other display apparatus according to the synchronization signal, and the second synchronization unit may include a second image input unit to which a second image signal is input, a synchronization signal input unit which receives the synchronization signal from the reference display apparatus, a second buffer which buffers the input second image signal by frame, a second image output unit which outputs the buffered second image signal, and a controlling unit which controls the buffer to output the buffered second image signal to the image output unit according to the synchronization signal.

The display system may further include a synchronization apparatus which outputs the synchronization signal, and the plurality of display apparatuses may receive the synchronization signal from the synchronization apparatus and display the input image according to the received synchronization signal.

The synchronization apparatus may include a synchronization signal generating unit which generates the synchronization signal and a synchronization signal output unit which outputs the synchronization signal.

A display apparatus from among the plurality of display apparatuses may include a second synchronization unit which outputs the image to be displayed on each the display apparatus according to the synchronization signal, and the second synchronization unit may include a second image input unit to which a second image signal is input, a synchronization signal input unit which receives the synchronization signal from the reference display apparatus, a second buffer which buffers the input second image signal by frame, a second image output unit which outputs the buffered second image signal, and a controlling unit which controls the buffer to output the buffered second image signal to the image output unit according to the synchronization signal.

The display system may be a multi-vision system in which the plurality of display apparatuses are combined to form a big screen.

The plurality of display apparatuses may be disposed on four sides of a rectangular parallelopipedon.

According to an aspect of another exemplary embodiment, there is provided a synchronization apparatus including a synchronization signal controlling unit which synchronizes a plurality of display apparatuses to output an input image according to a synchronization signal.

According to an aspect of another exemplary embodiment, there is provided a display apparatus including: an image input unit which receives an input image; and a synchronization unit which receives a synchronization signal and which controls the input image to be output in synchronization with another display apparatus according to the received synchronization signal.

According to an aspect of another exemplary embodiment, there is provided a method of displaying an input image on a plurality of display apparatuses, the method including: synchronizing the plurality of display apparatuses by a single synchronization signal; and displaying, by the synchronized plurality of display apparatuses, the input image.

### BRIEF DESCRIPTION OF THE DRAWINGS

The above and other aspects will become more apparent by describing in detail exemplary embodiments thereof with reference to the attached drawings in which:

FIG. 1 is a block diagram illustrating a construction of a synchronization apparatus according to an exemplary embodiment;

FIG. 2 is a block diagram illustrating a detailed construction of a synchronization signal controlling unit of a synchronization apparatus according to an exemplary embodiment;

FIG. 3 is a view illustrating a construction of a display apparatus including a synchronization unit according to an exemplary embodiment;

FIG. 4 is a view illustrating three-dimensional (3D) images displayed on a plurality of display apparatuses that are not synchronized with each other;

FIG. 5 is a view illustrating a display system in which a plurality of display apparatuses are synchronized by synchronization units included in the display apparatuses according to an exemplary embodiment;

FIG. 6 is a view illustrating a display system in which a plurality of display apparatuses are synchronized using separate synchronization apparatuses according to an exemplary embodiment;

FIG. 7 is a view illustrating a display system which outputs a plurality of 3D images synchronized by a High-Definition Multimedia Interface (HDMI) distributor according to an exemplary embodiment;

FIG. 8 is a view illustrating a display system in which a plurality of display apparatuses are synchronized using at least one HDMI switch disposed in at least one of the plurality of display apparatuses according to an exemplary embodiment;

FIG. 9 is a block diagram illustrating a construction of an HDMI switch according to an exemplary embodiment;

FIG. 10 is a view illustrating a display system in which a plurality of display apparatuses are synchronized using a separate synchronization apparatus according to an exemplary embodiment;

FIG. 11 is a view illustrating a display system in which a separate synchronization apparatus and a plurality of display apparatuses are connected and synchronized in the form of a chain according to an exemplary embodiment;

FIG. 12 is a view illustrating a rectangular parallelepiped multi-vision system in which a plurality of display apparatuses are synchronized according to an exemplary embodiment;

FIG. 13 is a view illustrating that a Digital Video Disc player (DVDP) transmits same images to each of first through fourth display apparatuses of a multi-vision system according to an exemplary embodiment;

FIG. 14 is a view illustrating that DVDP transmits different images to each of first through fourth display apparatuses of a multi-vision system according to an exemplary embodiment; and

FIG. 15 is a block diagram of 3D glasses according to an exemplary embodiment.

### DETAILED DESCRIPTION OF EXEMPLARY EMBODIMENTS

Certain exemplary embodiments are described in greater detail with reference to the accompanying drawings. In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail. Furthermore, expressions such as “at least one of,” when preceding a list of elements, modify the entire list of elements and do not modify the individual elements of the list.

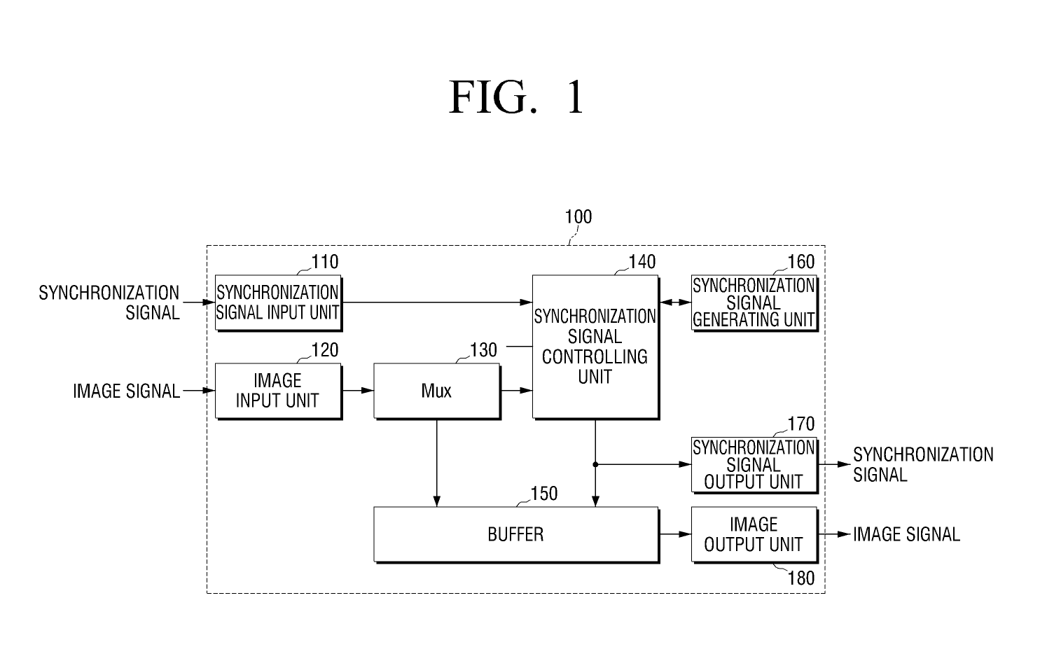

FIG. 1 is a block diagram illustrating a construction of a synchronization apparatus 100 according to an exemplary embodiment. As illustrated in FIG. 1, the synchronization apparatus 100 includes a synchronization signal input unit 110, an image input unit 120, a multiplexer (MUX) 130, a synchronization signal controlling unit 140, a buffer 150, a synchronization signal generating unit 160, a synchronization signal output unit 170, and an image output unit 180.

The synchronization signal input unit 110 receives a synchronization signal from an external apparatus. The synchronization signal controls when each frame of an input image is output. For example, a frequency of the synchronization signal may be the same as a frequency of outputting one image frame. If the input image is a three-dimensional (3D) image, the frequency of the synchronization signal may be the frequency of outputting a left eye image and a right eye image once. Examples of the synchronization signal include a horizontal (H) sync signal and a vertical (V) sync signal. In addition, the synchronization signal may be used to generate a glasses controlling signal which controls when 3D glasses for viewing 3D images are opened and closed.

The image input unit 120 receives an image signal from an external apparatus. For example, the image input unit 120 may receive the image signal from a Digital Video Disc (DVD) player or a Blu-ray Disc (BD) player. In addition, the image input unit 120 may receive the image signal via broadcasting using a broadcasting reception antenna and a tuner, or from an external receiving device such as a set-top box. The image input unit 120 may include one or more image signal interfaces. For instance, the image input unit 120 may include at least one of a Digital Video/Visual Interface (DVI) unit and a High-Definition Multimedia Interface (HDMI) unit. An image signal may be a 3D image signal including a left eye image and a right eye image.

The MUX 130 multiplexes the input image signal and transmits the multiplexed input image signal to the buffer 150.

The synchronization signal controlling unit 150 controls the buffer 150 so that the image signal, which has been buffered in the buffer 150, may be output to the image output unit 180 according to a synchronization signal input via the synchronization signal input unit 110. That is, when the synchronization signal is input to the synchronization signal input unit 110, the synchronization signal controlling unit 140 causes the buffered image signal to be displayed according to the input synchronization signal.

Furthermore, if the synchronization signal is not input to the synchronization signal input unit 110, the synchronization signal controlling unit 140 controls the buffer 150 so that the image signal, which has been buffered, may be output to the image output unit 180 according to a synchronization signal included in the received image signal. That is, if a separate synchronization signal is not input via the synchronization input unit 110, the synchronization signal controlling unit 140 causes the buffered image signal to be output according to the synchronization signal included in the received image signal.

That is, the image signal may include a synchronization signal to adjust when an image included in the image signal is displayed. Examples of the synchronization signal included in the image signal are a V sync signal and an H sync signal. Accordingly, the synchronization signal controlling unit 140 performs synchronization according to the synchronization signal included in the image signal if a separate synchronization signal is not input via the synchronization input unit 110.

If the image signal is not input to the image input unit 120, and the synchronization signal is not input to the synchronization input unit 110, the synchronization signal generating unit 160 may generate and output a synchronization signal. Since the image signal is not input in this case, the synchronization apparatus 100 generates and outputs only the synchronization signal.

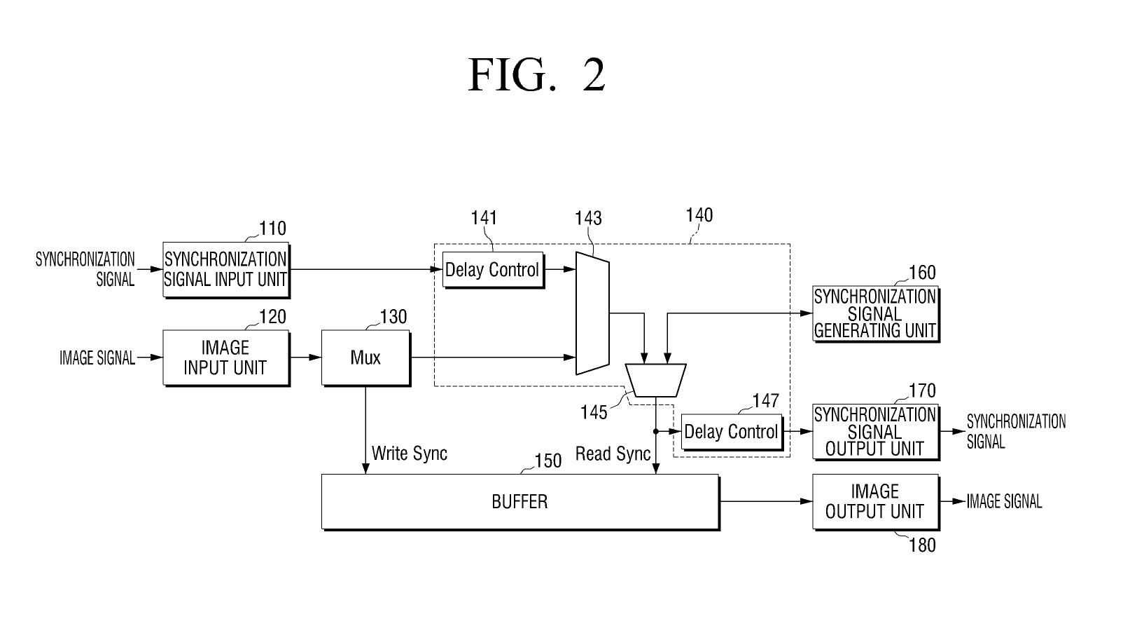

As described above, if a synchronization signal is input via the synchronization signal input unit 110, the synchronization signal controlling unit 140 performs synchronization according to the input synchronization signal. Conversely, if the synchronization signal is not input via the synchronization signal input unit 110, the synchronization signal controlling unit 140 performs synchronization according to the synchronization signal included in the image signal. A detailed construction of the synchronization signal controlling unit 140 according to an exemplary embodiment will be explained with reference to FIG. 2.

The buffer 150 buffers the image signal which is multiplexed by the MUX 130 by frame. In addition, the buffer 150 outputs the image signal which has been buffered under the control of the synchronization signal controlling unit 140 according to the synchronization signal. For instance, the buffer 150 may output an image signal corresponding to one frame for each synchronization signal.

The synchronization signal generating unit 160 generates a separate synchronization signal, and outputs the generated synchronization signal to the synchronization signal controlling unit 140.

The synchronization signal outputting unit 170 outputs the synchronization signal received from the synchronization signal controlling unit 140 to an external apparatus. For example, the synchronization signal outputting unit 170 may be connected to a display apparatus such as a television and may output the synchronization signal to the display apparatus.

The image output unit 180 outputs the image signal received from the buffer 150 to a connected external apparatus. For example, the image output unit 180 may be connected to a display apparatus such as a television and output an image signal to the display apparatus. In this case, the image output unit 180 outputs the image signal that is synchronized by the synchronization signal.

A detailed construction of the synchronization signal controlling unit 140 according to an exemplary embodiment will now be explained in detail with reference to FIG. 2. FIG. 2 is a block diagram illustrating the detailed construction of the synchronization signal controlling unit 140 of the synchronization apparatus 100 according to an exemplary embodiment.

As illustrated in FIG. 2, the synchronization signal controlling unit 140 includes a first Delay Control 141, a first multiplexer 143, a second multiplexer 145, and a second Delay Control 147.

The first Delay Control 141 controls a delay of the synchronization signal input through the synchronization signal input unit 110.

The first multiplexer 143 selects and outputs one of the synchronization signal input from the synchronization signal input unit 110 and a synchronization signal input from the MUX 130 (e.g., a frame lock signal). For example, if the synchronization signal from the synchronization signal input unit 110 and the synchronization signal from the MUX 130 are input simultaneously, the first multiplexer 143 may select and output the synchronization signal input from the synchronization signal input unit 110. If one of the synchronization signal from the synchronization signal input unit 110 and the synchronization signal from the MUX 130 is input, the first multiplexer 143 may select and output the one input synchronization signal.

The second multiplexer 145 outputs one of the synchronization signal output from the first multiplexer 143 and a synchronization signal output from the synchronization signal generating unit 160. For example, if the synchronization signal output from the first multiplexer 143 and the synchronization signal output from the synchronization signal generating unit 160 are input simultaneously, the second multiplexer 145 may select and output the synchronization signal output from the first multiplexer 143. If one of the synchronization signal output from the first multiplexer 143 and the synchronization signal output from the synchronization signal generating unit 160 is input, the second multiplexer 145 may select and output the one input synchronization signal.

The second Delay Control 147 outputs a synchronization signal to the synchronization signal output unit 170 by controlling a delay of the synchronization signal which is output from the second multiplexer 145.

If the buffer 150 receives a write sync signal from the MUX 130, the buffer 150 records an image signal. If the buffer 150 receives a read sync signal from the synchronization controlling unit 140, the buffer 150 outputs the recorded image signal to the image output unit 180. In this case, the synchronization controlling unit 140 outputs the read sync signal according to the synchronization signal. Accordingly, the buffer 150 may output the image signal according to the synchronization signal.

Thus, if a synchronization signal is input via the synchronization signal input unit 110, the synchronization signal controlling unit 140 synchronizes an image according to the input synchronization signal, or synchronizes the image according to the synchronization signal included in the image signal. If the synchronization signal is not input to the synchronization signal input unit 110 and the image signal is not input to the image input unit 120, the synchronization signal controlling unit 140 may output a synchronization signal generated by the synchronization signal generating unit 160.

Such a synchronization apparatus 100 may synchronize the input image signal according to the synchronization signal input from an external apparatus. In addition, the synchronization apparatus 100 may output the synchronization signal to the external apparatus. Accordingly, a plurality of 3D display apparatuses may be synchronized using the synchronization apparatus 100.

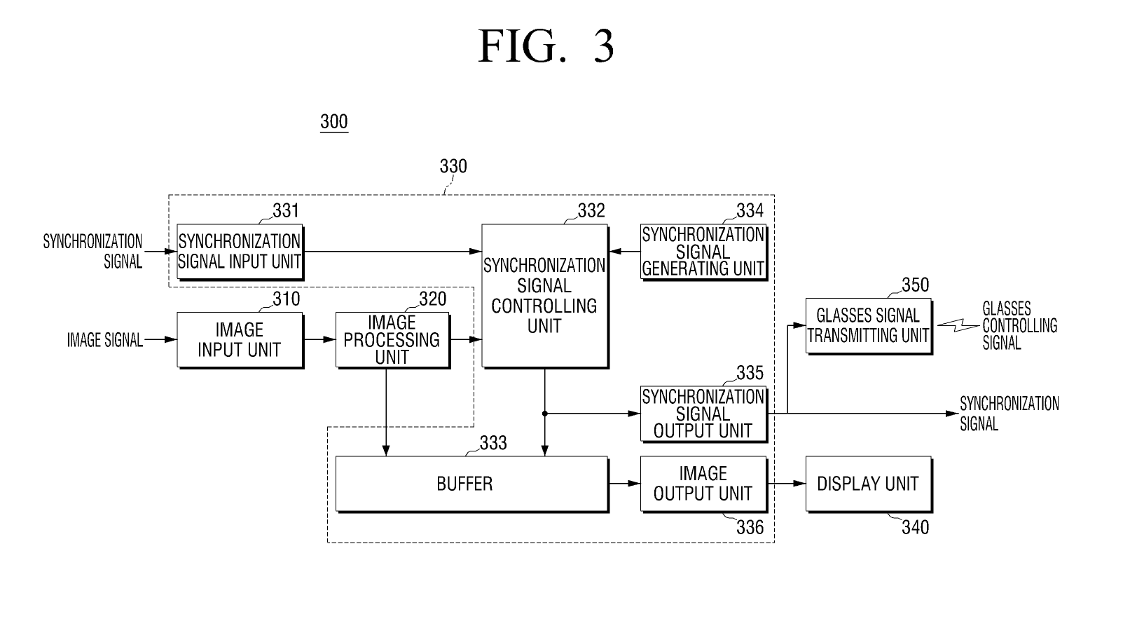

A detailed construction of a display apparatus 300 which includes a synchronization unit 330 according to an exemplary embodiment will now be explained with reference to FIG. 3. FIG. 3 is a view illustrating the construction of the display apparatus 300 including a synchronization unit according to an exemplary embodiment. As illustrated in FIG. 3, the display apparatus 300 includes an image input unit 310, an image processing unit 320, a synchronization unit 330, a display unit 340, and a glasses signal transmitting unit 350.

The image input unit 310 receives an image signal from an external apparatus. For example, the image input unit 310 may receive an image signal from a DVD player or a BD player. In addition, the image input unit may receive an image signal via broadcasting using a broadcasting reception antenna and a tuner, or an external receiving unit such as a set-top box. The image input unit 310 may include one or more image signal interfaces. For example, the image input unit 310 may include at least one of a DVI unit and an HDMI unit. The received image signal may be a 3D image signal including a left eye image and a right eye image.

The image processing unit 320 performs operations of processing signals such as video decoding, format analyzing, and video scaling on the input image signal. The image processing unit 320 may also add one or more graphical user interfaces (GUIs).

In addition, if the input image signal is the 3D image signal, the image processing unit 320 generates a left eye image and a right eye image, each of which corresponds to a resolution or size of a screen (e.g., 1920×1080), using a format of the 3D image signal. That is, if the format of the 3D image is a top-bottom type, a side by side type, a horizontal interleave type, a vertical interleave type, or a checker board type, the image processing unit 220 extracts a left eye image portion and a right eye image portion from each image frame, and upscales and/or interpolates the extracted left eye image and the right eye image, thereby generating a left eye image and a right eye image to be provided to the user.

The synchronization unit 330 receives a synchronization signal from an external apparatus and outputs the input image signal according to the synchronization signal. Specifically, the synchronization unit 330 includes a synchronization signal input unit 331, a synchronization signal controlling unit 332, a buffer 333, a synchronization signal generating unit 334, a synchronization signal output unit 335, and an image output unit 336.

The synchronization input unit 331 receives the synchronization signal from the external apparatus. The synchronization signal controls when each frame of the input image signal is output. For example, a frequency of the synchronization signal may be the same as a frequency of outputting one image frame. If the input image signal is the 3D image signal, the frequency of the synchronization signal may be a frequency of outputting a left eye image and a right eye image once. In addition, the synchronization signal may be used to control when 3D glasses for viewing 3D images are opened and closed.

The synchronization signal controlling unit 332 controls the buffer 333 so that the image signal, which has been buffered in the buffer 333, may be output to the image output unit 336 according the synchronization signal input via the synchronization signal input unit 331. That is, when the synchronization signal is input to the synchronization signal input unit 331, the synchronization signal controlling unit 332 causes the buffered image signal to be displayed according to the input synchronization signal.

In addition, if the synchronization signal is not input to the synchronization signal input unit 331, the synchronization signal controlling unit 332 controls the buffer 333 so that the image signal, which has been buffered, may be output to the image output unit 336 according to the synchronization signal included in the input image signal. That is, if a separate synchronization signal is not input via the synchronization input unit 331, the synchronization signal controlling unit 332 causes the buffered image signal to be output according to the synchronization signal included in the input image signal.

If the image signal is not input to the image input unit 310, and the synchronization signal is not input to the synchronization input unit 331, the synchronization signal generating unit 332 may output a synchronization signal generated by the synchronization generating unit 334. Since the image signal is not input in this case, the display apparatus 300 may generate and output only the synchronization signal.

The buffer 333 buffers the image signal output from the image processing unit 320 by frame. In addition, the buffer 333 outputs the image signal which has been buffered under the control of the synchronization signal controlling unit 332 according to the synchronization signal. For example, the buffer 333 may output an image signal corresponding to one frame for each synchronization signal.

The synchronization signal generating unit 334 generates a separate synchronization signal, and outputs the generated synchronization signal to the synchronization signal controlling unit 332.

The synchronization signal outputting unit 335 outputs the synchronization signal received from the synchronization signal controlling unit 334 to an external apparatus. For example, the synchronization signal outputting unit 335 may be connected to a display apparatus such as a television and may output the synchronization signal to the display apparatus.

The image output unit 336 outputs the image signal received from the buffer 333 to a connected external apparatus. For example, the image output unit 336 may be connected to a display apparatus such as a television and may output the image signal to the display apparatus. In this case, the image output unit 336 outputs the image signal that is synchronized by the synchronization signal.

The display unit 340 displays the image signal output from the synchronization unit 330. Accordingly, the display unit 340 displays the image signal according to the synchronization signal of the synchronization unit 330.

The glasses signal transmitting unit 350 transmits a glasses controlling signal corresponding to the synchronization signal output from the synchronization signal output unit 335 to 3D glasses. The glasses controlling signal controls when the 3D glasses are opened or closed based on the synchronization signal. The glasses signal transmitting unit 350 may transmit the glasses controlling signal in various ways such as through infrared ray communications.

As such, the display apparatus including the synchronization unit 330 may be a reference display apparatus which serves as a reference signal for the synchronization signal. In addition, the display apparatus including the synchronization unit 330 may be synchronized with the reference display apparatus by receiving the synchronization signal output from the reference display apparatus, thereby displaying an image. Accordingly, when a plurality of display apparatuses display 3D images, the plurality of display apparatuses may synchronize with each other when a left eye image and a right eye image are displayed. Therefore, a user may watch the 3D images displayed on the plurality of display apparatuses using a single pair of glasses.

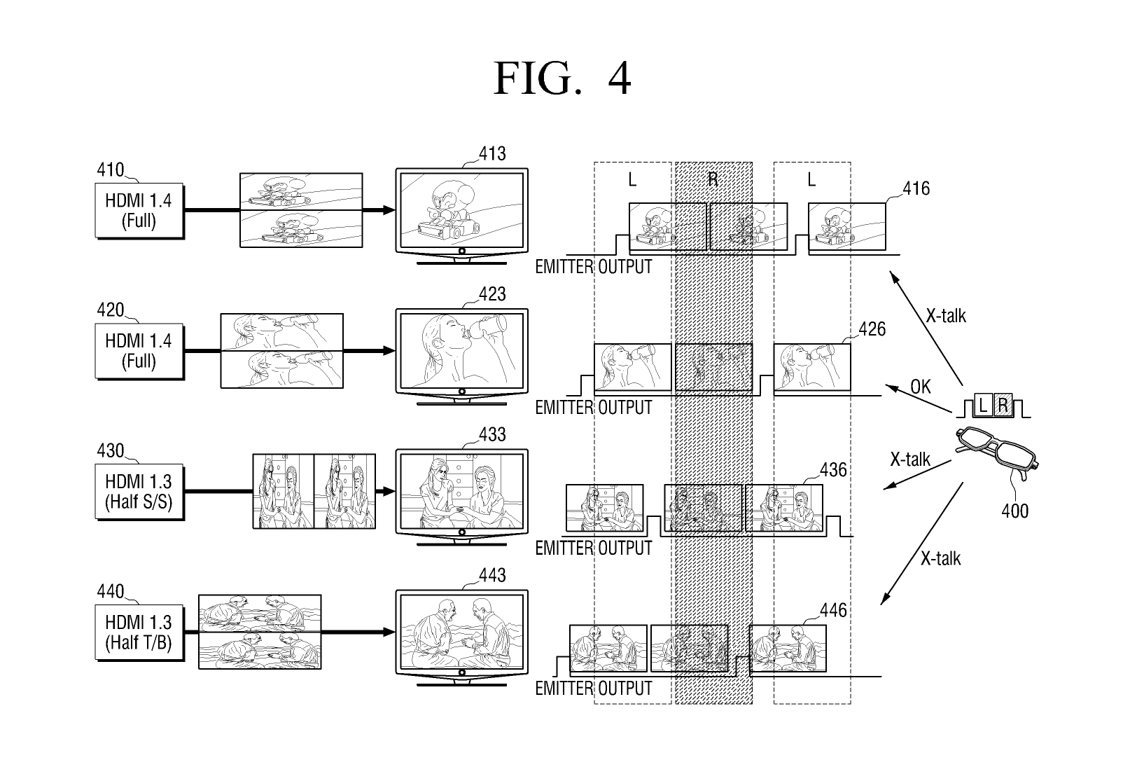

A method of synchronizing a plurality of display apparatuses which display 3D images using a synchronization apparatus and a display apparatus according to one or more exemplary embodiments is explained below with reference to FIGS. 4 to 11. The plurality of display apparatuses which are synchronized with each other is referred to herein as a display system.

FIG. 4 is a view illustrating 3D images displayed on a plurality of display apparatuses that are not synchronized with each other.

As illustrated in FIG. 4, four displays apparatuses 413, 423, 433, 443 receive 3D image signals through respective first through fourth image input units 410, 420, 430, 440. However, since the respective first through fourth 3D images 416, 426, 436, 446 are not synchronized when displayed, the left eye images and right eye images are displayed at different times.

Since the synchronization signal of the 3D glasses 400 is consistent with only that of the second 3D image 426, a user may watch only the second 3D image 426 normally using the 3D glasses 400 and may not watch the first 3D image 416, the third 3D image 436, and the fourth 3D image 446 normally.

As such, if the plurality of display apparatuses 413, 423, 433, 443 are not synchronized, the user may not watch all 3D images 416, 426, 436, 446 displayed on a plurality of display apparatuses 413, 423, 433, 443 using a single pair of 3D glasses 400. However, when the 3D images 416, 426, 436, 446 displayed on the plurality of display apparatuses 413, 423, 433, 443 are synchronized, the user may watch all the 3D images 416, 426, 436, 446 displayed on the plurality of display apparatuses 413, 423, 433, 443.

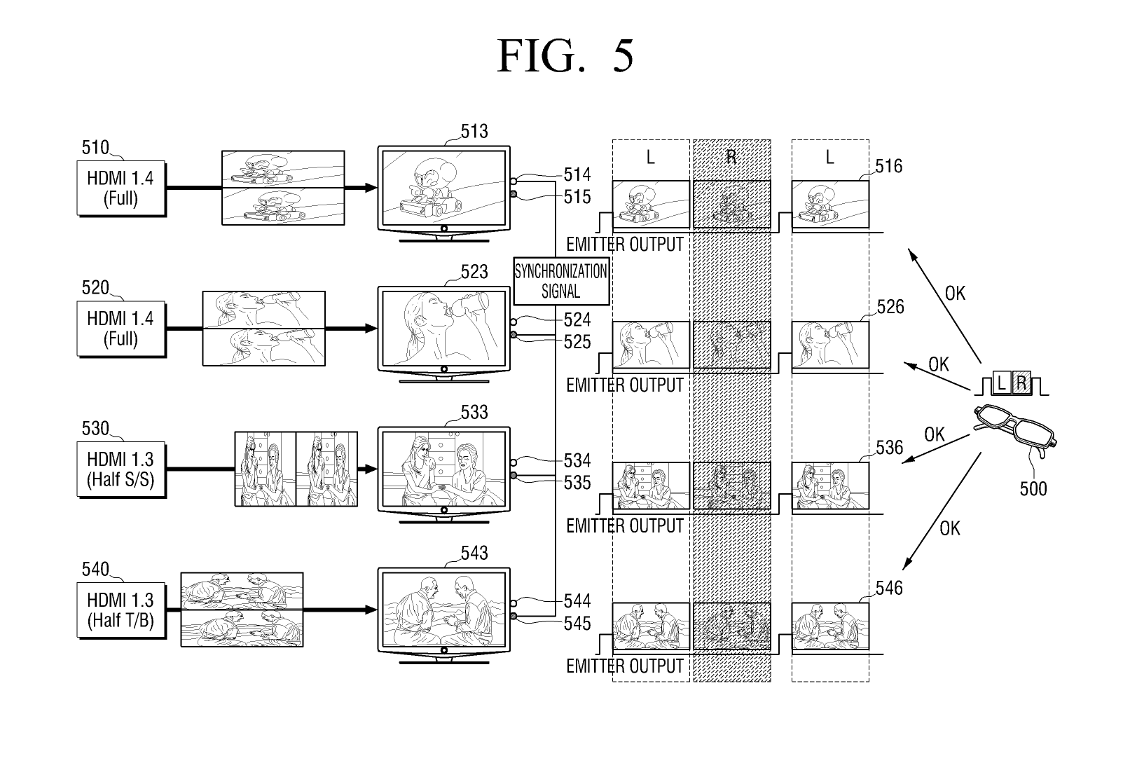

A method of synchronizing a plurality of display apparatuses is explained below with reference to FIGS. 5 to 11. In FIGS. 5 to 11, the image input units appear to be disposed outside of the respective display apparatuses, but this is only an example. It is understood that the image input units may be respectively disposed inside the display apparatuses.

The image input units in FIGS. 5 to 11 may receive image signals from different apparatuses or from a same apparatus. Moreover, a plurality of display apparatuses may receive the same image signals or different image signals from a single external apparatus. In addition, the plurality of display apparatuses may display different portions of the same image. Furthermore, the plurality of display apparatuses may each receive image signals from at least two external apparatuses, respectively.

FIG. 5 is a view illustrating a display system in which a plurality of display apparatuses 513, 523, 533, 543 are synchronized by synchronization units 330 included in the display apparatuses 513, 523, 533, 543 according to an exemplary embodiment.

As illustrated in FIG. 5, first through fourth display apparatuses 513, 523, 533, 543 receive 3D images through four image input units 510, 520, 530, 540. The frames of the 3D images input through the four image input units 510, 520, 530, 540 are different from each other, though it is understood that another exemplary embodiment is not limited thereto.

Each display apparatus 513, 523, 533, 543 in FIG. 5 includes the synchronization unit 330 such as illustrated in FIG. 3. Accordingly, the first through fourth display apparatuses 513, 523, 533, 543 include first through fourth synchronization signal output units 514, 524, 534, 544 and first through fourth synchronization signal input units 515, 525, 535, 545.

In FIG. 5, the first synchronization signal output unit 514 of the first display apparatus 513 is connected to the second synchronization signal input unit 525 of the second display apparatus 523, the third synchronization signal input unit 535 of the third display apparatus 533, and the fourth synchronization signal input unit 545 of the fourth display apparatus 543. Accordingly, the synchronization signal of the first display apparatus 513 is input to the second display apparatus 523, the third display apparatus 533, and the fourth display apparatus 543. Therefore, the second display apparatus 523, the third display apparatus 533, and the fourth display apparatus 543 are synchronized with respect to the synchronization signal of the first display apparatus 513. In this case, the first display apparatus 513 becomes the reference display apparatus.

Since the second display apparatus 523, the third display apparatus 533, and the fourth display apparatus 543 are synchronized with respect to the synchronization signal of the first display apparatus 513, 3D images 516, 526, 536, 546 are displayed on the first through fourth display apparatuses 513, 523, 533, 543 at the same time. Accordingly, a user may watch all of the 3D images 516, 526, 536, 546 displayed on the first display apparatus 513, the second display apparatus 523, the third display apparatus 533, and the fourth display apparatus 543 using the 3D glasses 500.

As such, a plurality of display apparatuses 513, 523, 533, 543 may be synchronized using a plurality of displaying apparatuses 513, 523, 533, 543, such as the display apparatus 300 illustrated in FIG. 3.

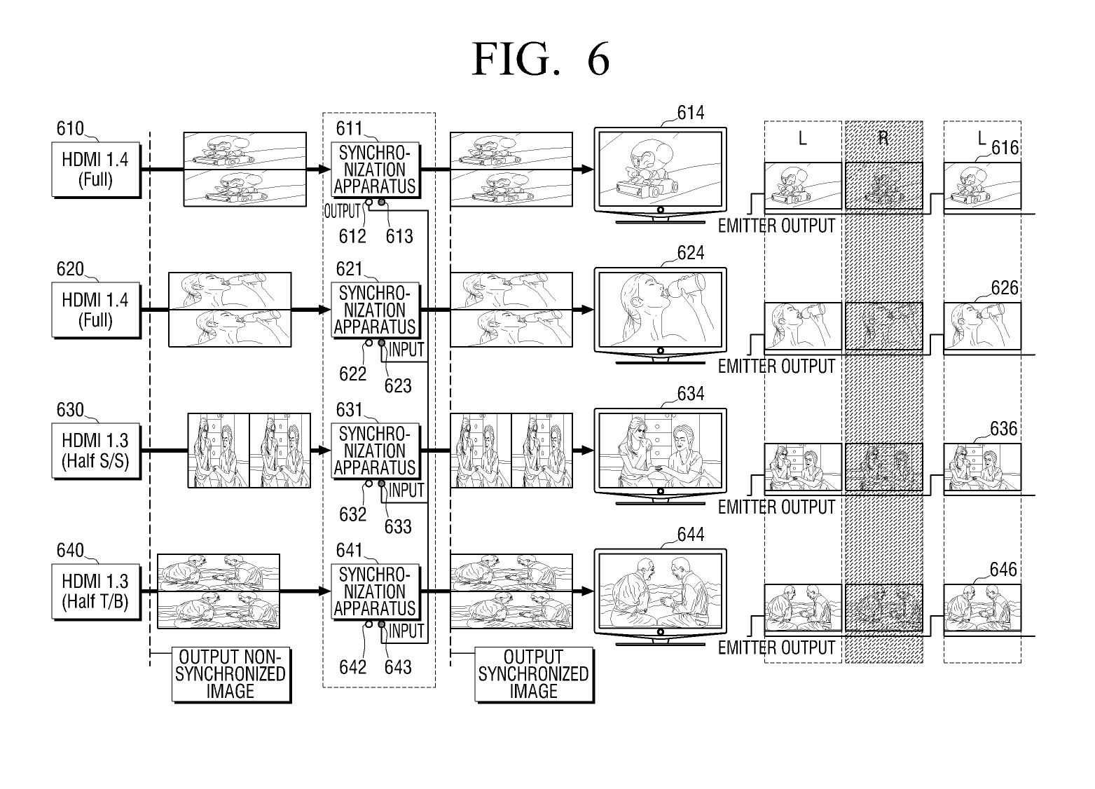

FIG. 6 is a view illustrating a display system in which a plurality of display apparatuses 614, 624, 634, 644 are synchronized using separate synchronization apparatuses 611, 621, 631, 641 according to an exemplary embodiment.

As illustrated in FIG. 6, first through fourth display apparatuses 614, 624, 634, 644 are connected to first through fourth synchronization apparatuses 611, 621, 631, 641. The first through fourth synchronization apparatuses 611, 621, 631, 641 have the same or similar construction as the synchronization apparatus 100 illustrated in FIG. 1. Accordingly, the first through fourth synchronization apparatuses 611, 621, 631, 641 include synchronization signal output units 612, 622, 632, 642 and synchronization signal input units 613, 623, 633, 643.

The first through fourth synchronization apparatuses 611, 621, 631, 641 receive 3D images through image input units 610, 620, 630, 640. Each frame of the 3D images input from the image input units 610, 620, 630, 640 may be different from each other. The four image input units 610, 620, 630, 640 output image signals without being synchronized with each other.

In FIG. 6, the first synchronization signal output unit 612 of the first synchronization apparatus 611 is connected to the second synchronization input unit 623 of the second synchronization apparatus 631, the third synchronization signal input unit 633 of the third synchronization apparatus 631, and the fourth synchronization signal input unit 643 of the fourth synchronization apparatus 641. Accordingly, the synchronization signal of the first synchronization apparatus 611 is input to the second synchronization apparatus 621, the third synchronization apparatus 631, and the fourth synchronization apparatus 641. Therefore, the second synchronization apparatus 621, the third synchronization apparatus 631, and the fourth synchronization apparatus 643 are synchronized with respect to the synchronization signal of the first synchronization apparatus 611. In this case, the first synchronization apparatus 611 becomes the reference display apparatus.

Since the second synchronization apparatus 621, the third synchronization apparatus 631, and the fourth synchronization apparatus 641 are synchronized with respect to the synchronization signal of the first synchronization apparatus 611, all the image signals output from the first through fourth display apparatuses 614, 624, 634, 644 are synchronized. Therefore, the 3D images 616, 626, 636, 646 are displayed on the first through fourth display apparatuses 614, 624, 634, 644 at the same time. Accordingly, a user may watch all of the 3D images displayed on the first display apparatus 614, the second display apparatus 624, the third display apparatus 634, and the fourth display apparatus 644 using the 3D glasses 500.

As such, a plurality of display apparatuses 614, 624, 634, 644 may be synchronized using a plurality of synchronization apparatuses 611, 621, 631, 641 having the same or similar construction as the synchronization apparatus 100 illustrated in FIG. 1.

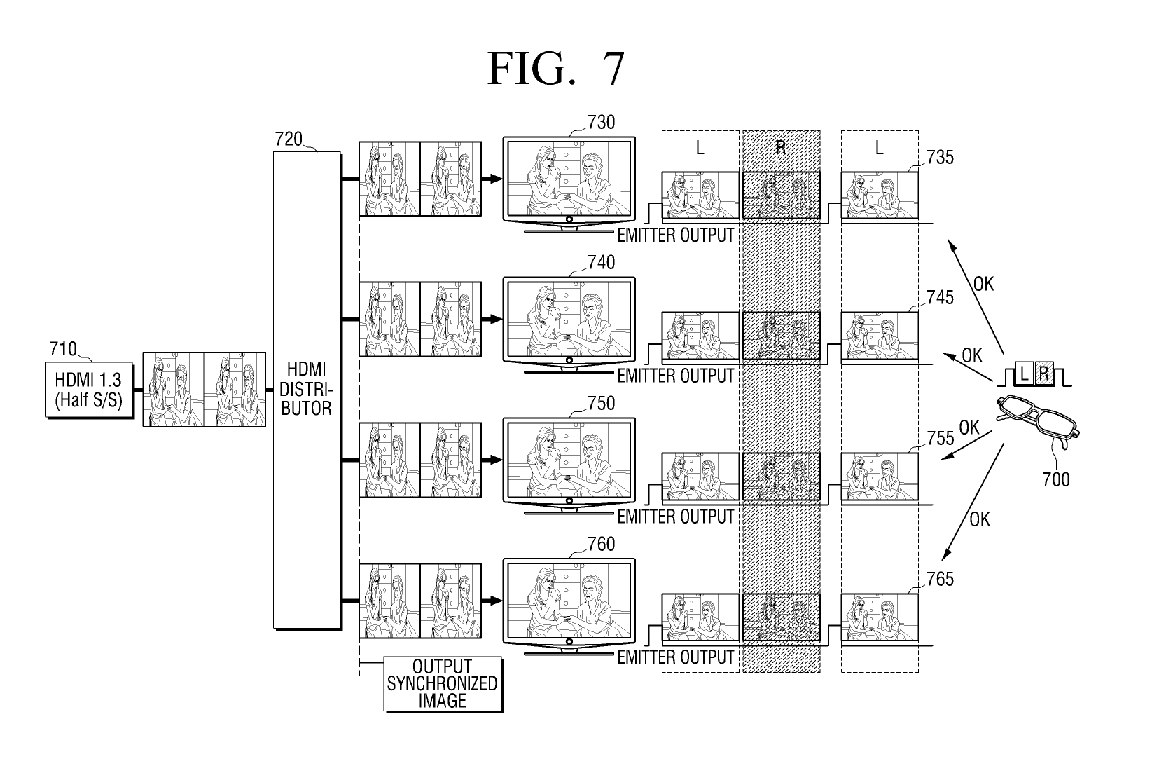

FIG. 7 is a view illustrating a display system which outputs a plurality of 3D images synchronized by an HDMI distributor 720 according to an exemplary embodiment.

As illustrated in FIG. 7, an image input unit 710 receives a 3D image, and the HDMI distributor 720 divides the input 3D image into four images 735, 745, 755, 765 and outputs the four images 735, 745, 755, 765 to first through fourth display apparatuses 730, 740, 750, 760. The HDMI distributor 720 outputs the four 3D images 735, 745, 755, 765 while being synchronized. Accordingly, the four images 735, 745, 755, 765 are displayed on the first through fourth display apparatuses 730, 740, 750, 760 at the same time. Therefore, a user may watch all of the 3D images displayed on the first through fourth display apparatuses 730, 740, 750, 760 using the 3D glasses 700.

As such, images of a plurality of display apparatuses 730, 740, 750, 760 may be synchronized using an HDMI distributor 720.

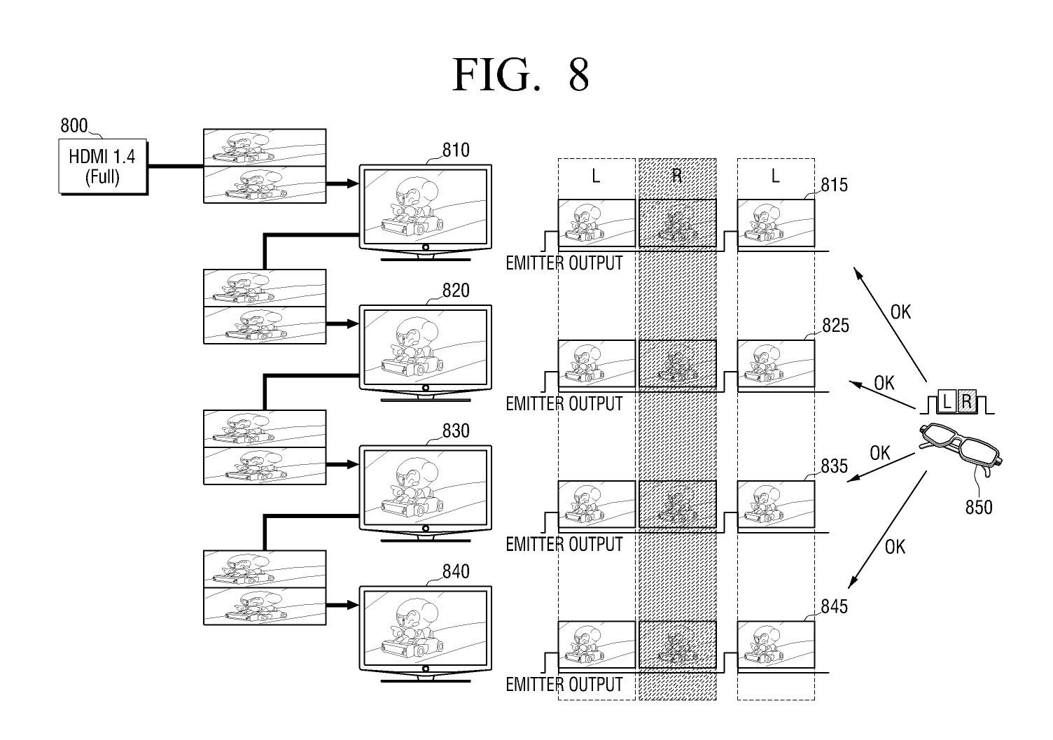

FIG. 8 is a view illustrating a display system in which a plurality of display apparatuses 810, 820, 830, 840 are synchronized using at least one HDMI switch (not shown) disposed in at least one of the plurality of display apparatuses according to an exemplary embodiment. In FIG. 8, the at least one HDMI switch (not shown) is disposed in at least one of the first display apparatus 810, the second display apparatus 820, the third display apparatus 830, and the fourth display apparatus 840. For example, the HDMI switch (not shown) may be disposed in the third display apparatus 830. The HDMI switch (not shown) refers to a switch apparatus including a plurality of HDMI input/output (I/O) ports.

As illustrated in FIG. 8, the first display apparatus 810 receives a 3D image through the image input unit 800. The first display apparatus 810 is connected to the second display apparatus 820 via the at least one HDMI switch (not shown). The second display apparatus 820 is connected to the third display apparatus 830 via the at least one HDMI switch (not shown). The third display apparatus 830 is connected to the fourth display apparatus 840 via the at least one HDMI switch (not shown). Accordingly, the image input to the first display apparatus 810 is transmitted to the second display apparatus 820, the third display apparatus 830, and the fourth display apparatus 840, respectively.

Therefore, the first through fourth display apparatuses 810, 820, 830, 840 display 3D images 815, 825, 835, 845 while being synchronized. Accordingly, the images 815, 825, 835, 845 are displayed on the display apparatuses 810, 820, 830, 840 at the same time. Consequently, a user may watch all of the 3D images 815, 825, 835, 845 displayed on the display apparatuses 810, 820, 830, 840 using the 3D glasses 850.

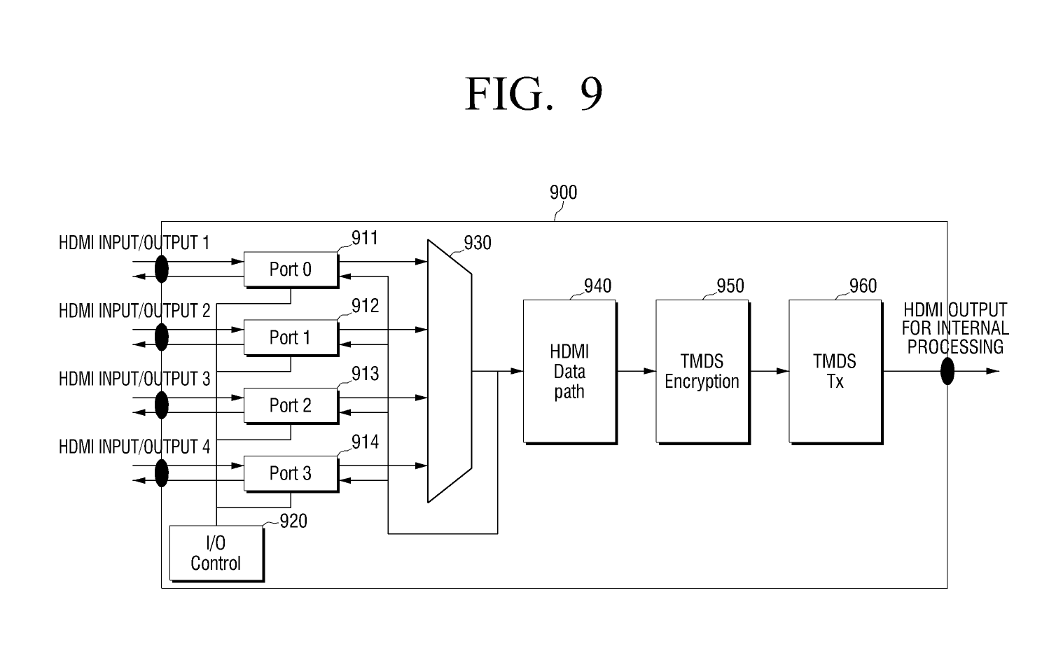

FIG. 9 is a block diagram illustrating a construction of an HDMI switch 900 according to an exemplary embodiment. As illustrated in FIG. 9, the HDMI switch 900 includes a plurality of I/O ports 911, 912, 913, 914, an I/O Control 920, a multiplexer 930, an HDMI data path 940, a Transmission Minimized Differential Signaling (TMDS) Encryption unit 950, and a TMDS transmitter (Tx) 960.

The plurality of I/O ports 911, 912, 913, 914 are connected to a plurality of HDMI apparatuses serving as a path for inputting/outputting data.

The I/O Control 920 controls the input/output of the plurality of I/O ports 911, 912, 913, 914.

The multiplexer 930 selects a signal from among the signals input from the ports 911, 912, 913, 914 and outputs the selected signal to the HDMI Data path 940.

The HDMI Data path 940 transmits the input HDMI data (i.e., the selected signal) to the TMDS Encryption unit 950. The TMDS Encryption 950 encrypts the input HDMI data in a TMDS form. The TMDS Tx 960 transmits the TMDS signal (i.e., the encrypted input HDMI data) to the a display apparatus within which the HDMI switch 900 is disposed.

As such, 3D images displayed on a plurality of display apparatuses may be synchronized using a plurality of display apparatuses including at least one HDMI switch.

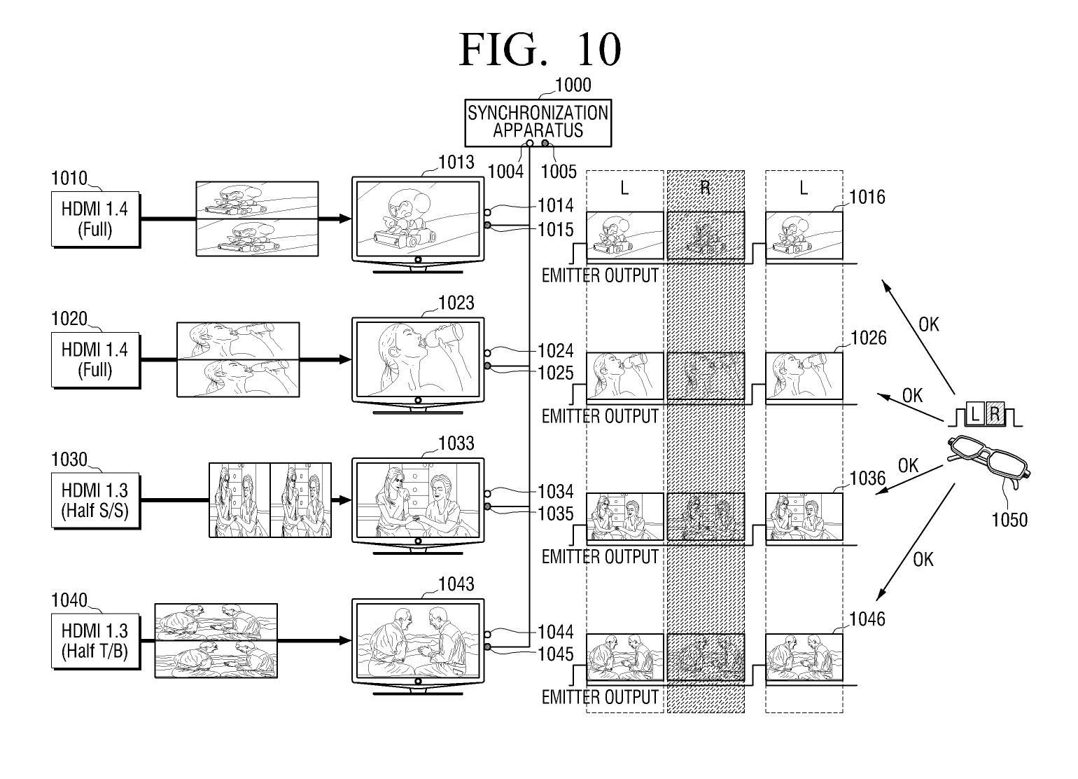

FIG. 10 is a view illustrating a display system in which a plurality of display apparatuses 1013, 1023, 1033, 1043 are synchronized using a separate synchronization apparatus 1000 according to an exemplary embodiment.

As illustrated in FIG. 10, first through fourth display apparatuses 1013, 1023, 1033, 1043 receive 3D images via image input units 1010, 1020, 1030, 1040. Each frame of the 3D images input from the image input units 1010, 1020, 1030, 1040 may be different from each other.

The synchronization apparatus 1000 in FIG. 10 may have the same or similar construction as the synchronization apparatus 100 illustrated in FIG. 1. The synchronization apparatus 1000 includes a synchronization signal output unit 1004 and a synchronization signal input unit 1014.

Each display apparatus 1013, 1023, 1033, 1043 illustrated in FIG. 10 includes the synchronization unit 330 such as illustrated in FIG. 3. Accordingly, the first through fourth display apparatuses 1013, 1023, 1033, 1043 include first through fourth synchronization signal output units 1014, 1024, 1034, 1044 and first through fourth synchronization input units 1015, 1025, 1035, 1045.

In FIG. 10, the synchronization signal output unit 1004 of the synchronization apparatus 1000 is connected to the first synchronization signal input unit 1015 of the first display apparatus 1013, the second synchronization signal input unit 1025 of the second display apparatus 1023, the third synchronization signal input unit 1035 of the third display apparatus 1033, and the fourth synchronization signal input unit 1045 of the fourth display apparatus 1043. Accordingly, the synchronization signal generated from the synchronization apparatus 1000 is input to the first display apparatus 1013, the second display apparatus 1023, the third display apparatus 1033, and the fourth display apparatus 1043. Therefore, the first display apparatus 1013, the second display apparatus 1023, the third display apparatus 1033, and the fourth display apparatus 1043 are synchronized with respect to the synchronization signal of the synchronization apparatus 1000. In this case, the synchronization apparatus 1000 becomes the reference apparatus for synchronization.

Since the first display apparatus 1013, the second display apparatus 1023, the third display apparatus 1033, and the fourth display apparatus 1043 are synchronized with respect to the synchronization signal of the synchronization apparatus 1000, the 3D images 1016, 1026, 1036, 1046 are displayed on the first through fourth display apparatuses at the same time. Accordingly, a user may watch the 3D images 1016, 1026, 1036, 1046 displayed on the first display apparatus 1013, the second display apparatus 1023, the third display apparatus 1033, and the fourth display apparatus 1043 using the 3D glasses 1050.

As such, a plurality of display apparatuses 1013, 1023, 1033, 1043 may be synchronized using the plurality of display apparatuses 1013, 1023, 1033, 1043, such as the display apparatus 300 illustrated in FIG. 3, and a synchronization apparatus 1000, such as the synchronization apparatus 100 illustrated in FIG. 1.

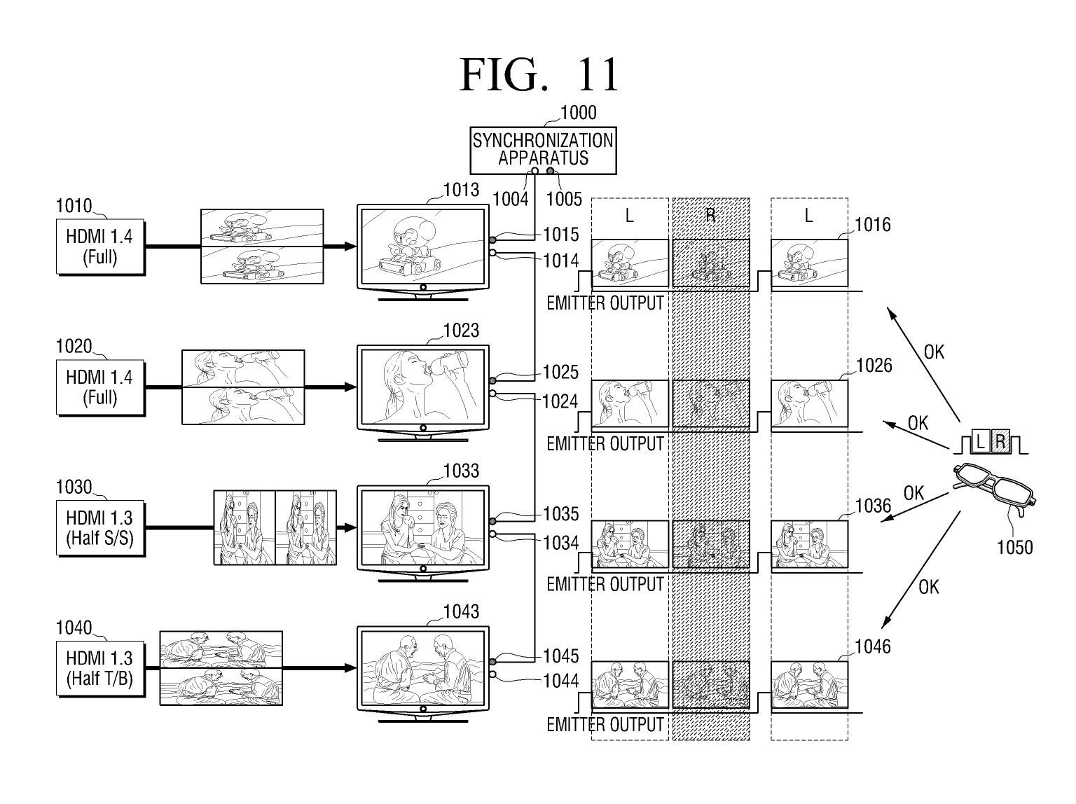

FIG. 11 is a view illustrating a display system in which a separate synchronization apparatus 1000 and a plurality of display apparatuses 1013, 1023, 1033, 1043 are connected and synchronized in the form of a chain according to an exemplary embodiment. In FIG. 11, locations of the first through fourth synchronization signal output units 1014, 1024, 1034, 1044 and locations of the first through fourth synchronization signal input units 1015, 1025, 1035, 1045 of the first through fourth display apparatuses 1013, 1023, 1033, 1043 are changed with each other in comparison with FIG. 10.

As illustrated in FIG. 11, the first through fourth display apparatuses 1013, 1023, 1033, 1043 receive 3D images through image input units 1010, 1020, 1030, 1040. Each frame of the 3D images input from the image input units 1010, 1020, 1030, 1040 may be different from each other.

The synchronization apparatus 1000 in FIG. 11 may have the same or similar construction to the synchronization apparatus 100 illustrated in FIG. 1. The synchronization apparatus 1000 includes a synchronization output unit 1004 and a synchronization input unit 1014.

Each display apparatus 1013, 1023, 1033, 1043 illustrated in FIG. 11 includes the synchronization unit 330 such as illustrated in FIG. 3. Therefore, the first through fourth display apparatuses 1013, 1023, 1033, 1043 include first through fourth synchronization signal output units 1014, 1024, 1034, 1044 and first through fourth synchronization signal input units 1015, 1025, 1035, 1045.

In FIG. 11, the synchronization signal output unit 1004 of the synchronization apparatus 1000 is connected to the first synchronization signal input unit 1015 of the first display apparatus 1013, the first synchronization signal output unit 1014 of the first display apparatus 1013 is connected to the second synchronization signal input unit 1025 of the second display apparatus 1023, the second synchronization signal output unit 1024 of the second display apparatus 1023 is connected to the third synchronization signal input unit 1035 of the third display apparatus 1033, and the third synchronization signal output unit 1034 of the third display apparatus 1033 is connected to the fourth synchronization signal input unit 1045 of the fourth display apparatus 1043. That is, the first through fourth display apparatuses 1013, 1023, 1033, 1043 in FIG. 11 are connected with each other in the form of a chain.

Accordingly, the synchronization signal generated from the synchronization apparatus 1000 is input to the first display apparatus 1013, the second display apparatus 1023, the third display apparatus 1033, and the fourth display apparatus 1043. Therefore, the first display apparatus 1013, the second display apparatus 1023, the third display apparatus 1033, and the fourth display apparatus 1043 are synchronized with respect to the synchronization signal of the synchronization apparatus 1000. In this case, the synchronization apparatus 1000 becomes the reference apparatus for synchronization.

Since the first display apparatus 1013, the second display apparatus 1023, the third display apparatus 1033, and the four display apparatus 1043 are synchronized with respect the synchronization signal of the synchronization apparatus 1000, the 3D images 1016, 1026, 1036, 1046 are displayed on the four display apparatuses at the same time. Therefore, a user may watch the 3D images 1016 1026, 1036, 1046 displayed on the first display apparatus 1013, the second display apparatus 1023, the third display apparatus 1033, and the fourth display apparatus 1043 using the 3D glasses 1050.

As such, a plurality of display apparatuses 1013, 1023, 1033, 1043 may be synchronized using the plurality of display apparatuses 1013, 1023, 1033, 1043, such as the display apparatus 300 illustrated in FIG. 3, and the synchronization apparatus 1000, such as the synchronization apparatus 100 illustrated in FIG. 1.

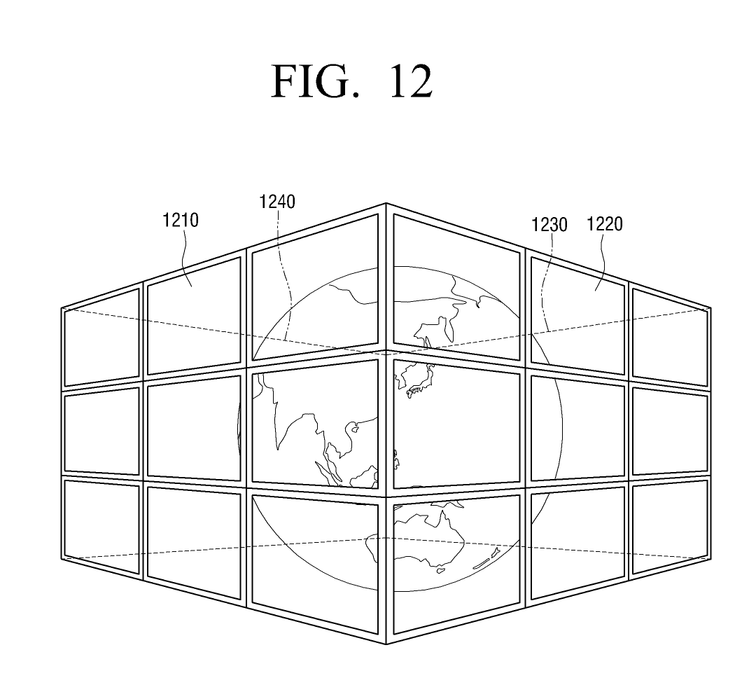

The aforementioned display systems may form a multi-vision system. The multi-vision system refers to a display system that displays a single image or different images on a plurality of screens. Accordingly, the multi-vision system includes a plurality of display apparatuses. If one or more of the aforementioned exemplary embodiments are applied to a multi-vision system, the multi-vision system may display 3D images, which will be described with reference to FIG. 12.

FIG. 12 is a view illustrating a rectangular parallelepiped multi-vision system in which a plurality of display apparatuses are synchronized according to an exemplary embodiment.

The multi-vision system illustrated in FIG. 12 has a rectangular parallelepiped shape in which nine display apparatuses are provided on each of four sides 1210, 1220, 1230, 1240. Accordingly, the multi-vision system in FIG. 12 has a rectangular parallelepiped shape with 36 display apparatuses.

The multi-vision system in FIG. 12 may designate one of the 36 display apparatuses as a reference display apparatus and synchronize the remaining 35 display apparatuses with respect to the synchronization signal of the reference display apparatus, thereby synchronizing all of the 36 display apparatuses. Accordingly, the multi-vision system in FIG. 12 may display 3D images.

The four rectangular parallelepiped sides 1210, 1220, 1230, 1240 of the multi-vision system in FIG. 12 include multi-vision screens. Accordingly, a user may feel as if a 3D object exists inside the multi-vision system.

As such, in order for a user to watch 3D images displayed on a multi-vision system using 3D glasses, all of the display apparatuses included in the multi-vision should be synchronized. A period when a left eye glass and a right eye glass of the 3D glasses are opened or closed is synchronized with a period when a left eye image and a right eye image are displayed on a plurality of display screens of the multi-vision system. Accordingly, a user can normally watch 3D images displayed on the plurality of display apparatuses of a multi-vision system using the 3D glasses. By applying the display system that is synchronized according to one or more of the aforementioned exemplary embodiments, the multi-vision system is capable of displaying synchronized 3D images.

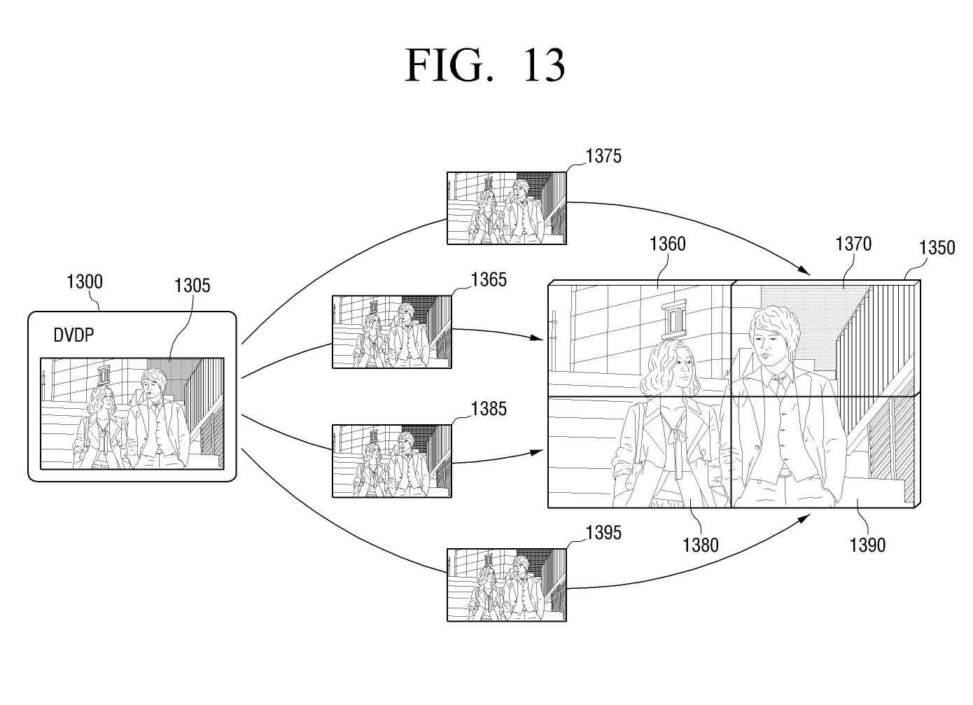

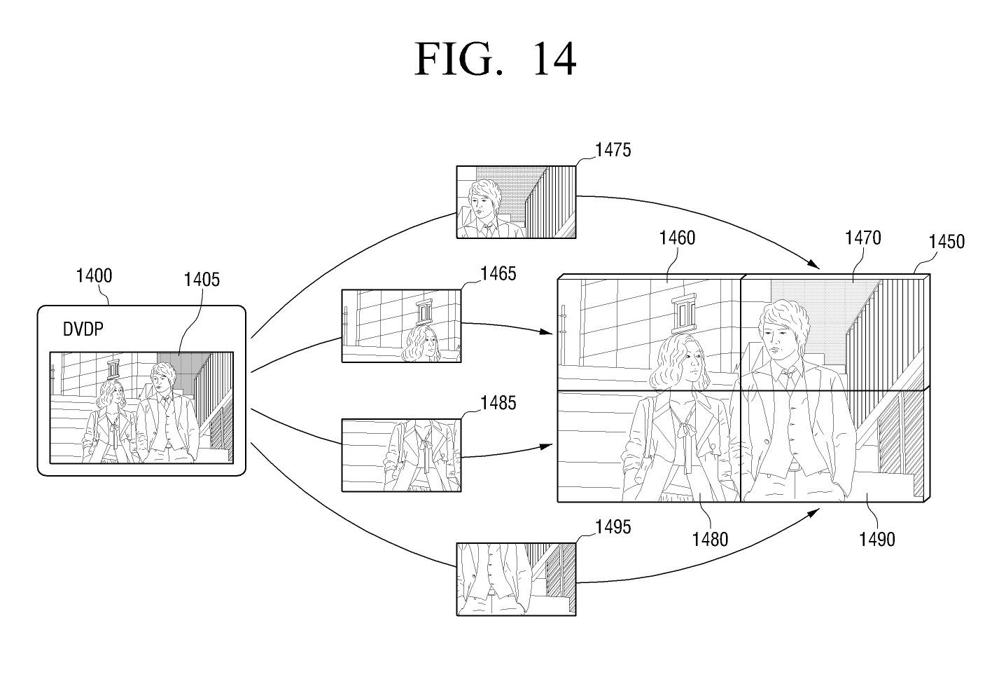

A method of providing images to a multi-vision is explained below with reference to FIGS. 13 and 14. FIG. 13 is a view illustrating an image providing device (such as, though not limited though, a Digital Video Disc player (DVDP 1300)) transmits the same images to first through fourth display apparatuses 1360, 1370, 1380, 1390 of a multi-vision system 1350 according to an exemplary embodiment. While a DVDP 1300 is illustrated as an example of an image providing device in FIG. 13, it is understood that other exemplary embodiments are not limited thereto. For example, according to another exemplary embodiment, the image providing device may be a Blu-ray disc (BD) player, an external storage device such as a server or hard disk drive, a general-purpose or special-purpose computer, a workstation, a development platform, etc.

As illustrated in FIG. 13, the DVDP 1300 loads a DVD image 1305 from an inserted DVD, and transmits the loaded DVD image 1305 to the first through fourth display apparatuses 1360, 1370, 1380, 1390 of the multi-vision system 1350. In this case, the first display apparatus 1360, the second display apparatus 1370, the third display apparatus 1380, and the fourth display apparatus 1390 receive the first image 1365, the second image 1375, the third image 1385 and the fourth image 1395, which are the same images as the DVD image 1305.

The first display apparatus 1360 divides the input first image 1365 into four images, and extracts and displays the upper left image. The second display apparatus 1370 divides the input second image 1375 into four images, and extracts and displays the upper right image. The third display apparatus 1380 divides the input third image 1385 into four images, and extracts and displays the lower left image. The fourth display apparatus 1390 divides the input fourth image 1395 into four images, and extracts and displays the lower right image.

As each display apparatus 1360, 1370, 1380, 1390 displays different parts of the same input image 1305, the multi-vision system 1350 displays the DVD image 1305 input from the DVDP 1300 on a big screen.

During the above process, the display apparatuses 1360, 1370, 1380, 1390 are synchronized with each other according to a single synchronization signal, and thus each frame of the image 1305 is displayed at the same time. In particular, if the DVD image 1305 is a 3D image, the display apparatuses 1360, 1370, 1380, 1390 display left eye images and right eye images alternately according to a single synchronization signal. One or more of the first through fourth display apparatuses 1360, 1370, 1380, 1390 generates a glasses controlling signal using the synchronization signal and transmits the generated glasses signal to 3D glasses. Accordingly, a user may watch the 3D images displayed on the first through fourth display apparatuses 1360, 1370, 1380, 1390 of the multi-vision system 1350 using the 3D glasses.

FIG. 14 is a view illustrating that an image providing device (such as, but not limited to, a DVDP 1400) transmits different images to each of first through fourth display apparatuses 1460, 1470, 1480, 1490 of a multi-vision system 1450 according to an exemplary embodiment. While a DVDP 1400 is illustrated as an example of an image providing device in FIG. 14, it is understood that other exemplary embodiments are not limited thereto. For example, according to another exemplary embodiment, the image providing device may be a Blu-ray disc (BD) player, an external storage device such as a server or hard disk drive, a general-purpose or special-purpose computer, a workstation, a development platform, etc.

As illustrated in FIG. 14, the DVDP 1400 loads a DVD image 1405 from an inserted DVD, and transmits the loaded DVD image 1405 to the first through fourth display apparatuses 1460, 1470, 1480, 1490 of the multi-vision system 1450. In this case, the first display apparatus 1460, the second display apparatus 1470, the third display apparatus 1480, and the fourth display apparatus 1490 receive the first image 1465, the second image 1475, the third image 1485 and the fourth image 1495, which is the DVD image 1405 divided up into four pieces. The first image 1465 corresponds to the upper left piece of the DVD image 1405. The second image 1475 corresponds to the upper right piece of the DVD image 1405. The third image 1485 corresponds to the lower left piece of the DVD image 1405. The fourth image 1495 corresponds to the lower right piece of the DVD image 1405.

The first through fourth display apparatuses 1460, 1470, 1480, 1490 display the first image 1465, the second image 1475, the third image 1485, and the fourth image 1495.

As each display apparatus 1460, 1470, 1480, 1490 displays a different part of the same input image 1405, the multi-vision system 1150 displays the DVD image 1405 input from the DVDP 1100 on a big screen.

During the above process, the first through fourth display apparatuses 1460, 1470, 1480, 1490 are synchronized with each other according to a single synchronization signal, and thus each frame of the image 1405 is displayed at the same time. In particular, if the DVD image 1405 is a 3D image, the first through fourth display apparatuses 1460, 1470, 1480, 1490 display left eye images and right eye images alternately according to a single synchronization signal. One or more of the first through fourth display apparatuses 1460, 1470, 1480, 1490 generates a glasses controlling signal using the synchronization signal and transmits the generated glasses signal to 3D glasses. Accordingly, a user may watch the 3D images displayed on the first through fourth display apparatuses 1460, 1470, 1480, 1490 of the multi-vision system 1450 using the 3D glasses.

As described above, according to an exemplary embodiment, a plurality of display apparatuses included in a display system are synchronized by a single synchronization signal to display an input image. In particular, if the input image is a 3D image including a left eye image and a right eye image, the plurality of display apparatuses display the left eye image and the right eye image alternately according to a synchronization signal.

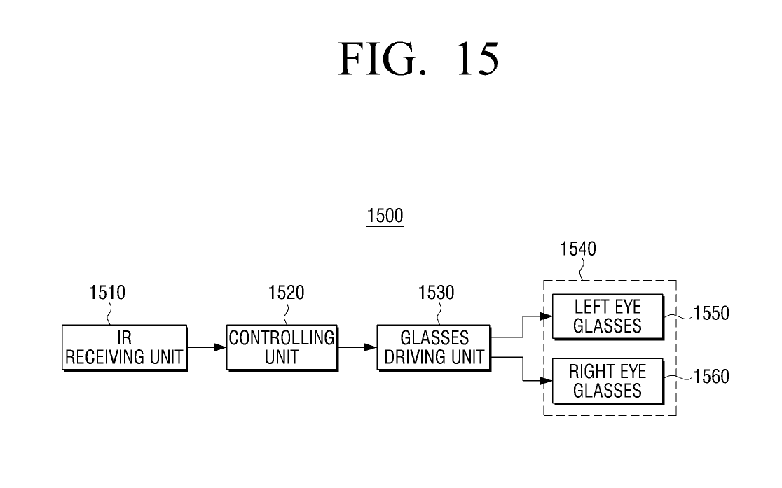

If the input image is a 3D image, the display system may include 3D glasses. A construction of the 3D glasses 1500 according to an exemplary embodiment will now be explained with reference to FIG. 15. The 3D glasses 1500 opens and closes left eye glasses 1550 and right eye glasses 1560 alternately according to a glasses controlling signal received from at least one display apparatus, thereby enabling a user to watch the left eye image and the right eye image with a left eye and a right eye, respectively.

FIG. 15 is a block diagram of the 3D glasses 1500 according to an exemplary embodiment. As illustrated in FIG. 15, the 3D glasses 1500 includes an infrared (IR) receiving unit 1510, a controlling unit 1520, a glasses driving unit 1530, and a glasses unit 1540.

The IR receiving unit 1510 receives a glasses controlling signal corresponding to the synchronization signal of a 3D image from at least one display apparatus which is connected wired or wirelessly. The at least one display apparatus transmits the glasses controlling signal using straight infrared rays through an IR transmitting unit, and the IR receiving unit 1510 of the 3D glasses 1500 receives the glasses controlling signal by receiving the transmitted (e.g., radiated) infrared rays.

For example, the glasses controlling signal transmitted from the at least one display apparatus to the IR receiving unit 1510 may be a signal in which a first period of high level and a second period of low level are alternately repeated at predetermined time intervals. In this case, the 3D glasses may operate such that the left eye glasses 1550 opens during the first period of high level and the right eye glasses 1560 opens during the second period of low level, or vice-versa according to another exemplary embodiment.

The IR receiving unit 1510 transmits the glasses controlling signal received from the at least one of a plurality of display apparatuses to the controlling unit 1520.

The controlling unit 1520 controls overall operation of the 3D glasses 1500. In particular, the controlling unit 1520 controls an operation of the glasses driving unit 1530 by transmitting the glasses controlling signal received from the IR receiving unit 1510 to the glasses driving unit 1530. The controlling unit 1520 controls the glasses driving unit 1530 so that a driving signal to drive the glasses unit 1540 may be generated from the glasses driving unit 1530 based on the glasses controlling signal of the controlling unit 1530.

The glasses driving unit 1530 generates the driving signal based on the glasses controlling signal received from the controlling unit 1520. In particular, the glasses unit 1540, which will be explained below, includes the left eye glasses 1550 and the right eye glasses 1560. Thus, the glasses driving unit 1530 generates a left eye driving signal to drive the left eye glasses 1550 and a right eye driving signal to drive the right eye glasses 1560 and transmits the generated left eye driving signal to the left eye glasses 1550 and the generated right eye driving signal to the right eye glasses 1560.

As described above, the glasses unit 1540 includes the left eye glasses 1550 and the right eye glasses 1560, and opens and closes each of the glasses 1550, 1560 alternately according to the driving signal received from the glasses driving unit 1530.

Using the 3D glasses 1500 having the above-mentioned construction, a user may watch a left eye image and a right eye image displayed on a plurality of display apparatuses with the left eye and the right eye alternately.

As described above, according to an exemplary embodiment, at least one of a plurality of display apparatuses generates a glasses controlling signal using a synchronization signal and transmits the generated glasses controlling signal to 3D glasses 1500. The 3D glasses 1500 receives the glasses controlling signal from the at least one of the plurality of display apparatuses and synchronizes when left eye glasses 1550 and right eye glasses 1560 open or close according to the received glasses controlling signal.

As such, in a plurality of display apparatuses included in a display system, periods when a left eye image and a right eye image are displayed are synchronized with each other according to a single synchronization signal. In addition, periods when the left eye image and the right eye image of a 3D image are displayed are synchronized with when the left glasses 1550 and the right glasses 1560 of the 3D glasses 1500 are opened or closed, according to a glasses controlling signal.

For example, the first period and the second period may be repeated in a synchronization signal, and the first period and the second period of a glasses controlling signal may be repeated as being synchronized with the synchronization signal. In this case, all of the plurality of display apparatuses display left eye images during the first period of the synchronization signal, and display right eye images during the second period of the synchronization signal. The 3D glasses 1500 may be driven in a way that the left eye glasses 1550 are opened and the right eye glasses 1560 are closed during the first period and the left eye glasses 1550 are closed and the right eye glasses 1560 are opened during the second period. Accordingly, a user may watch 3D images displayed on a plurality of display apparatuses in a display system using the 3D glasses 1500.

In the above-described exemplary embodiments, the display apparatus may be any apparatus which is capable of displaying 3D images, such as a television, a monitor, a portable multimedia player (PMP), a personal computer, a laptop computer, a tablet computer, a projector device, etc.

While not restricted thereto, exemplary embodiments can also be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, exemplary embodiments may be written as computer programs transmitted over a computer-readable transmission medium, such as a carrier wave, and received and implemented in general-use or special-purpose digital computers that execute the programs. Moreover, while not required in all aspects, one or more units of the above-described display apparatuses, synchronization apparatuses, and 3D glasses can include a processor or microprocessor executing a computer program stored in a computer-readable medium.

Although a few exemplary embodiments have been shown and described, it would be appreciated by those skilled in the art that changes may be made in the exemplary embodiments without departing from the principles and spirit of the present inventive concept, the scope of which is defined in the claims and their equivalents.

What is claimed is:

1. A display system comprising:
a plurality of display apparatuses which display a plurality of input images,
wherein the plurality of display apparatuses are synchronized by a synchronization signal to display the plurality of input images.

2. The display system according to claim 1, wherein:
the plurality of input images are three-dimensional (3D) images comprising left eye images and right eye images; and
the plurality of display apparatuses display the left eye images and the right eye images alternately according to the synchronization signal.

3. The display system according to claim 2, further comprising:
3D glasses comprising left eye glasses and right eye glasses,
wherein the 3D glasses receives a controlling signal from at least one of the plurality of display apparatuses and synchronizes periods when the left eye glasses and the right eye glasses are opened or closed according to the received controlling signal, and
the at least one of the plurality of display apparatuses generates the controlling signal using the synchronization signal and transmits the generated controlling signal to the 3D glasses.

4. The display system according to claim 3, wherein:
periods when the left eye images and the right eye images are displayed on the plurality of display apparatuses are synchronized according to the synchronization signal; and
the periods when the left eye images and the right eye images of the 3D images are displayed on the plurality of display apparatuses are synchronized with the periods when the left eye glasses and the right eye glasses of the 3D glasses are opened or closed according to the controlling signal.

5. The display system according to claim 4, wherein:
a first period of the synchronization signal and a second period of the synchronization signal, which is directly adjacent to the first period, are repeated in the synchronization signal;
a first period of the controlling signal and a second period of the controlling signal are synchronized with the synchronization signal and are repeated in the controlling signal;
the plurality of display apparatuses display the left eye images during the repeated first periods of the synchronization signal and display the right eye images during the repeated second periods of the synchronization signal; and
the 3D glasses operates such that the left eye glasses are opened and the right eye glasses are closed during the first period of the glasses controlling signal and the left eye glasses are closed and the right eye glasses are opened during the second period of the controlling signal.

6. The display system according to claim 1, wherein the plurality of display apparatuses receive the plurality of input images from an external apparatus.

7. The display system according to claim 6, wherein the plurality of input images are different images.

8. The display system according to claim 6, wherein the plurality of input images are same images.

9. The display system according to claim 8, wherein the plurality of display apparatuses display different portions of the same images received from the external apparatus.

10. The display system according to claim 1, wherein the plurality of display apparatuses receive the plurality of input images from at least two external apparatuses.

11. The display system according to claim 1, wherein:
a reference display apparatus from among the plurality of display apparatuses outputs the synchronization signal; and
other display apparatuses, other than the reference display apparatus from among the plurality of display apparatuses, receive the output synchronization signal and display the input images according to the received synchronization signal.

12. The display system according to claim 11, wherein:
the reference display apparatus comprises a first synchronization unit which outputs the synchronization signal for a first input image, among the plurality of input images, to be displayed on the reference display apparatus, the first synchronization unit comprising:
a first image input unit to which the first input image is input, the first input image comprising the synchronization signal,
a first buffer which buffers the first input image by frame,
a first image output unit which outputs the buffered first input image,
a first controlling unit which controls the buffer to output the buffered first input image to the image output unit according to the synchronization signal, and
a synchronization signal output unit which outputs the synchronization signal; and
the reference display apparatus displays the first input image output from the image output unit.

13. The display system according to claim 11, wherein:
the reference display apparatus comprises a first synchronization unit which outputs the synchronization signal for a first input image, among the plurality of input images, to be displayed on the reference display apparatus, the first synchronization unit comprising:
a first image input unit to which the first input image is input,
a synchronization signal generating unit which generates the synchronization signal,
a first buffer which buffers the first input image by frame,
a first image output unit which outputs the buffered first input image,
a first controlling unit which controls the buffer to output the buffered first input image to the image output unit according to the generated synchronization signal, and
a synchronization signal output unit which outputs the generated synchronization signal; and
the reference display apparatus displays the first input image output from the image output unit.

14. The display system according to claim 11, further comprising:
a glasses transmitting unit which generates a controlling signal to synchronize periods when left eye glasses and right eye glasses of 3D glasses are opened or closed using the synchronization signal and transmits the generated controlling signal.

15. The display system according to claim 11, wherein a display apparatus, from among the other display apparatuses other than the reference display apparatus, comprises a second synchronization unit which outputs a second input image, from among the plurality of input images, to be displayed on the display apparatus according to the received synchronization signal, the second synchronization unit comprising:
a second image input unit to which the second input image is input;
a synchronization signal input unit which receives the synchronization signal from the reference display apparatus;
a second buffer which buffers the input second input image by frame;
a second image output unit which outputs the buffered second input image; and
a controlling unit which controls the buffer to output the buffered second input image to the image output unit according to the received synchronization signal.

16. The display system according to claim 1, further comprising:
a synchronization apparatus which outputs the synchronization signal;
wherein the plurality of display apparatuses receive the output synchronization signal from the synchronization apparatus and display the plurality of input images according to the received synchronization signal.

17. The display system according to claim 16, wherein the synchronization apparatus comprises:
a synchronization signal generating unit which generates the synchronization signal; and
a synchronization signal output unit which outputs the generated synchronization signal.

18. The display system according to claim 16, wherein a display apparatus of the plurality of display apparatuses comprises a second synchronization unit which outputs a second input image, from among the plurality of input images, to be displayed on the display apparatus according to the received synchronization signal, the second synchronization unit comprising:
a second image input unit to which the second input image is input;
a synchronization signal input unit which receives the synchronization signal;
a second buffer which buffers the second input image by frame;
a second image output unit which outputs the buffered second input image; and
a controlling unit which controls the buffer to output the buffered second input image to the image output unit according to the received synchronization signal.

19. The display system according to claim 1, wherein the display system is a multi-vision system in which the plurality of display apparatuses are combined to form a big screen.

20. The display system according to claim 1, wherein the plurality of display apparatuses are disposed on four sides of a rectangular parallelopipedon.

21. The display system according to claim 1, further comprising:
a first synchronization apparatus which receives a first input image, from among the plurality of input images, transmits the synchronization signal, and outputs the first input image to a first display apparatus, among the plurality of display apparatuses, according to the synchronization signal; and
a second synchronization apparatus which receives a second input image, from among the plurality of input images, receives the transmitted synchronization signal, and outputs the second input image to a second display apparatus, among the plurality of display apparatuses, according to the received synchronization signal.

22. The display system according to claim 1, further comprising:
a High-Definition Multimedia Interface (HDMI) distributor which outputs a first input image, from among the plurality of input images, to a first display apparatus, among the plurality of display apparatuses, according to the synchronization signal, and outputs a second input image, from among the plurality of input images, to a second display apparatus, among the plurality of display apparatuses, according to the synchronization signal.

23. The display system according to claim 1, wherein the plurality of display apparatuses are synchronized by the synchronization signal using at least one HDMI switch disposed in at least one of the plurality of display apparatuses to distribute the input images to the plurality of display apparatuses.

24. The display system according to claim 1, further comprising:
a synchronization apparatus which outputs the synchronization signal;
wherein a first display apparatus, among the plurality of display apparatuses, receives the output synchronization signal from the synchronization apparatus, displays a first input image, from among the plurality of input images, according to the received synchronization signal, and outputs the received synchronization to a second display apparatus, among the plurality of display apparatuses.

25. A synchronization apparatus comprising:
a synchronization signal controlling unit which synchronizes a plurality of display apparatuses to output a plurality of input images according to a synchronization signal.

26. The synchronization apparatus according to claim 25, further comprising a synchronization signal generating unit which generates the synchronization signal.

27. The synchronization apparatus according to claim 25, further comprising:
an image input unit which receives the plurality of input images; and
an image output unit which outputs the received input images to the plurality of display apparatuses according to the synchronization signal.

28. The synchronization apparatus according to claim 27, wherein at least one of the input images comprises the synchronization signal, and the image output unit outputs the received input images to the plurality of display apparatuses according to the synchronization signal comprised in the input image.

29. The synchronization apparatus according to claim 25, further comprising a synchronization signal input unit which receives the synchronization signal from an external apparatus.

30. A display apparatus comprising:
an image input unit which receives an input image; and
a synchronization unit which receives a synchronization signal and which controls the input image to be output in synchronization with another display apparatus according to the received synchronization signal.

31. A method of displaying a plurality of input images on a plurality of display apparatuses, the method comprising:
synchronizing the plurality of display apparatuses by a synchronization signal; and
displaying, by the synchronized plurality of display apparatuses, the plurality of input images.

32. A computer readable recording medium having recorded thereon a program executable by a computer for performing the method of claim 31.
